(19) United States
(12) Patent Application Publication
(10) Pub. No.: US 2026/0022610 A1
(43) Pub. Date: Jan. 22, 2026

(54) CLIMBING STICK SYSTEM

(71) Applicant: SEQUOIA OUTDOORS, LLC, Aurora, OH (US)

(72) Inventors: Shawn Patrick Ferguson, Venetia, PA (US); Nickolas Betts, Pittsburgh, PA (US)

(21) Appl. No.: 19/015,955

(22) Filed: Jan. 10, 2025

Related U.S. Application Data
(60) Provisional application No. 63/673,365, filed on Jul. 19, 2024.

(51) Int. Cl. E06C 1/34; E06C 1/38

(52) U.S. Cl. CPC E06C 1/34; E06C 1/381

(57) ABSTRACT

A first climbing stick and the second climbing stick cooperate to define a deployed condition when attached to a tree so as to allow a user to ascend and descend the tree. The first climbing stick and the second climbing stick each include a main body, at least one standoff extending from the main body and configured to engage the tree, and at least one step configured to engage a foot of the user when in the deployed condition. The at least one step of the first climbing stick defines at least one passage configured to receive at least part of the standoff of the second climbing stick when the first climbing stick and the second climbing stick are removed from the tree and the second climbing stick is stacked on top of the first climbing stick so as to define a stowed condition.

### BACKGROUND

Sectional climbing sticks can be temporarily attached to a tree to aid a user in climbing to an elevated position in the tree and subsequently descending from the tree. As will be appreciated, sectional climbing sticks can be used across a wide array of applications to aid users. For example, the elevation position could be beneficial for hunting, scouting, photography, and videography of game.

As compared to traditional climbing sticks, sectional climbing sticks provide numerous advantages. For example, because of their compact size, the user can easily carry the sectional climbing sticks to the desired location and deploy the sectional sticks. Then, if an alternate location is desired, the sectional climbing sticks can be stowed and the user can rapidly relocate to a different location. However, known sectional climbing sticks can be bulky and not as sturdy as may be desired by the user. As such, improvements are needed.

### SUMMARY

According to an aspect, a climbing stick system includes a first climbing stick and a second climbing stick. The first climbing stick and the second climbing stick cooperate to define a deployed condition when attached to an associated tree so as to allow an associated user to ascend and descend the associated tree. The first climbing stick and the second climbing stick each include a main body, at least one standoff extending from the main body and configured to engage the associated tree, and at least one step configured to engage an associated foot of the associated user when in the deployed condition. The at least one step of the first climbing stick defines at least one passage configured to receive at least part of the standoff of the second climbing stick when the first climbing stick and the second climbing stick are removed from the associated tree and the second climbing stick is stacked on top of the first climbing stick so as to define a stowed condition.

The at least one step of the first climbing stick and the second climbing stick each include an upper step and a lower step for selective engagement with the associated foot of the associated user. Further, the upper step of the first climbing stick and the upper step of the second climbing stick each define an upper first passage and an upper second passage, and the lower step of the first climbing stick and the lower step of the second climbing stick each define a lower first passage and a lower second passage. The at least one standoff of the second climbing stick includes an upper first arm and an upper second arm that join at an upper vertex and cooperate to define an upper included angle of the second climbing stick that allows for receipt of the associated tree at least partially therein when in the deployed condition.

The upper first arm of the second climbing stick and the upper second arm of the second climbing stick each include an inner face that faces toward the associated tree when in the deployed condition and an outer face that faces in an opposite direction as the respective inner face of the second climbing stick and away from the associated tree when in the deployed condition. Further, the upper first arm of the second climbing stick defines a stepped shape so that a straight line extending from the upper vertex of the second climbing stick to a terminal end of the upper first arm of the second climbing stick along the inner face of the upper first arm of the second climbing stick does not maintain constant contact with the inner face of the upper first arm of the second climbing stick.

A straight line extending from the upper vertex of the second climbing stick to the terminal end of the upper first arm of the second climbing stick along the outer face of the upper first arm of the second climbing stick does not maintain constant contact with the outer face of the upper first arm of the second climbing stick. The upper second arm of the second climbing stick defines a stepped shape so that a straight line extending from the upper vertex of the second climbing stick to a terminal end of the upper second arm of the second climbing stick along the inner face of the upper second arm of the second climbing stick does not maintain constant contact with the inner face of the upper second arm of the second climbing stick. A straight line extending from the upper vertex of the second climbing stick to the terminal end of the upper second arm of the second climbing stick along the outer face of the upper second arm of the second climbing stick does not maintain constant contact with the outer face of the upper second arm of the second climbing stick.

The main body of the first climbing stick includes a post portion that extends between the upper step of the first climbing stick and the lower step of the first climbing stick, the post portion extending primarily in a vertical direction when the first climbing stick is in the deployed condition, and the post portion of the first climbing stick defines a plurality of holes that cooperate to define a hole volume.

The at least one passage of the first climbing stick defines a passage volume of the first climbing stick that is less than the hole volume of the first climbing stick. The upper passage of the first climbing stick and the lower first passage of the first climbing stick define an upper passage first climbing stick volume and a lower passage first climbing stick volume. The upper passage first climbing stick volume and the lower passage first climbing stick volume are equal to one another.

The upper passage of the second climbing stick defines an upper passage second climbing stick volume and the lower passage of the second climbing stick defines a lower second passage second climbing stick volume. The upper passage second climbing stick volume is equal to the lower second passage second climbing stick volume. A sum of the upper passage first climbing stick volume and the lower passage first climbing stick volume is equal to a sum of the upper passage second climbing stick volume and the lower second passage second climbing stick volume.

The at least one standoff of the first climbing stick includes an upper first arm and an upper second arm that join at an upper vertex and cooperate to define an upper included angle of the first climbing stick that allows for receipt of the associated tree at least partially therein when in the deployed condition.

The upper first arm of the first climbing stick and the upper second arm of the first climbing stick each include an inner face that faces toward the associated tree when in the deployed condition and an outer face that faces in an opposite direction as the respective inner face and away from the associated tree when in the deployed condition.

The upper first arm of the first climbing stick defines a stepped shape so that a straight line extending from the upper vertex of the first climbing stick to a terminal end of the upper first arm of the first climbing stick along the inner face of the upper first arm of the first climbing stick does not maintain constant contact with the inner face of the upper first arm of the first climbing stick.

The outer face of the upper first arm of the first climbing stick and the outer face of the upper second arm of the first climbing stick directly contact the inner face of the upper first arm of the second climbing stick and the inner face of the upper second arm of the second climbing stick when in the stowed condition. The at least one step of the first climbing stick is spaced from the at least one step of the second climbing stick when in the stowed condition.

The main body of the first climbing stick includes a post portion that extends between the upper step of the first climbing stick and the lower step of the first climbing stick, the post portion extending primarily in a vertical direction when the first climbing stick is in the deployed condition. The main body also includes a first support arm that extends from the post portion to an upper first portion of the upper step and a second support arm that extends from the post portion to an upper second portion of the upper step.

The first support arm, the post portion, and the upper step cooperate to define a first support void, and the second support arm, the post portion, and the upper step cooperate to define a second support void. The first support void defines a first support void volume and the second support void defines a second support void that is equal to the first support void. The upper first passage of the first climbing stick and the upper second passage of the first climbing stick define an upper first passage volume and an upper second passage volume, respectively. The upper first passage volume and the upper second passage volume are greater than the first support void volume and the second support void volume, respectively.

The main body of the first climbing stick includes a first tab that defines a first opening and a second tab that defines a second opening, the first opening and the second opening of the first and second tab, respectively, configured to allow passage of an associated rope to be passed therethrough to attach the first climbing stick to the associated tree. The first opening and the second opening define a first opening volume and a second opening volume, respectively. The upper passage of the first climbing stick and the lower first passage of the first climbing stick define an upper passage first climbing stick volume and a lower passage first climbing stick volume. A sum of the first opening volume and the second opening volume is less than a sum of the upper passage first climbing stick volume and the lower passage first climbing stick volume.

### BRIEF DESCRIPTION OF THE DRAWINGS

FIG. 1 is a perspective view of a climbing stick system that includes a plurality of climbing sticks attached to a tree;

FIG. 2 is a front elevation view of the climbing stick;

FIG. 3 is a front perspective view of the climbing stick;

FIG. 4 is a rear perspective view of the climbing stick;

FIG. 5 is a top plan view of the climbing stick;

FIG. 6 is a front perspective view of several climbing sticks nested together in a stowed condition; and

FIG. 7 is a top plan view of several climbing sticks nested together in the stowed condition.

### DETAILED DESCRIPTION

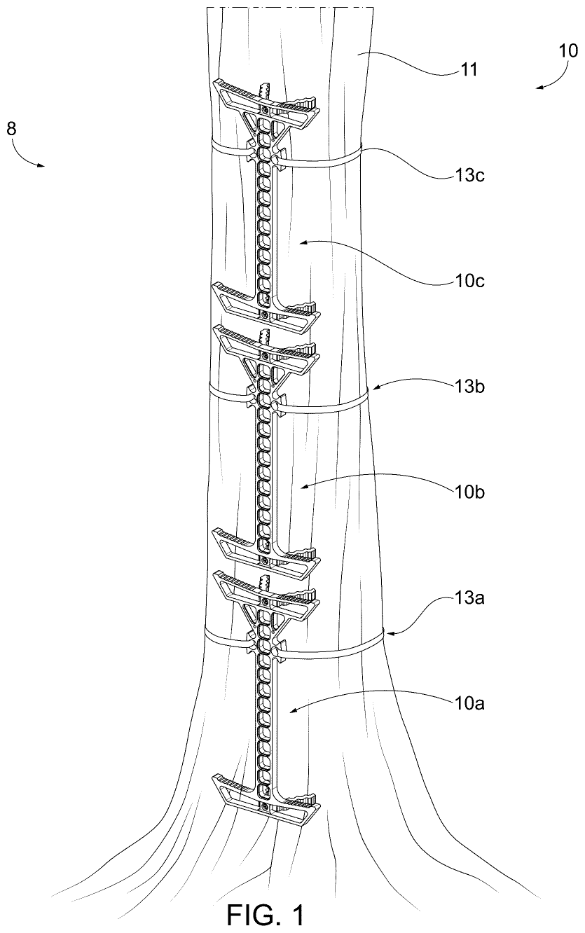

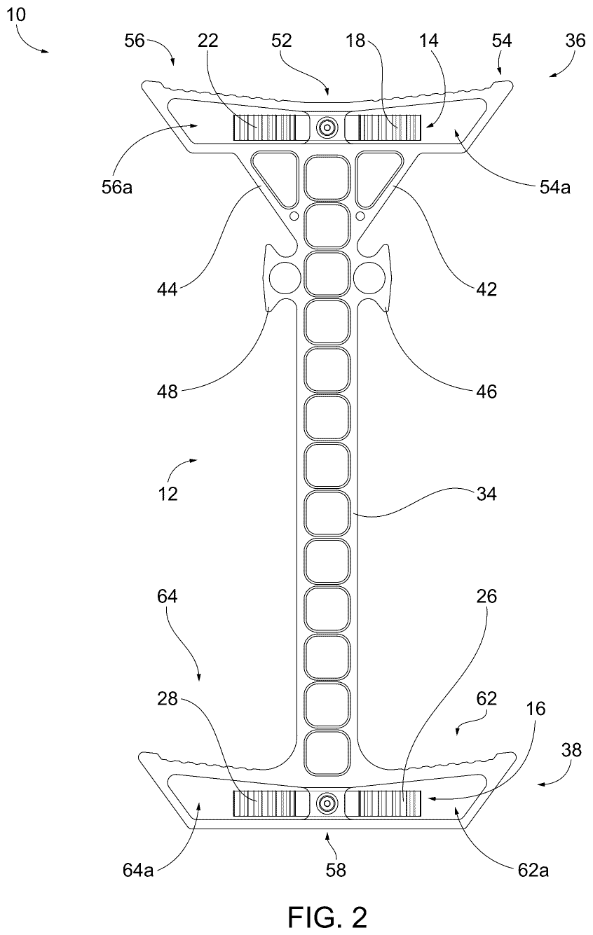

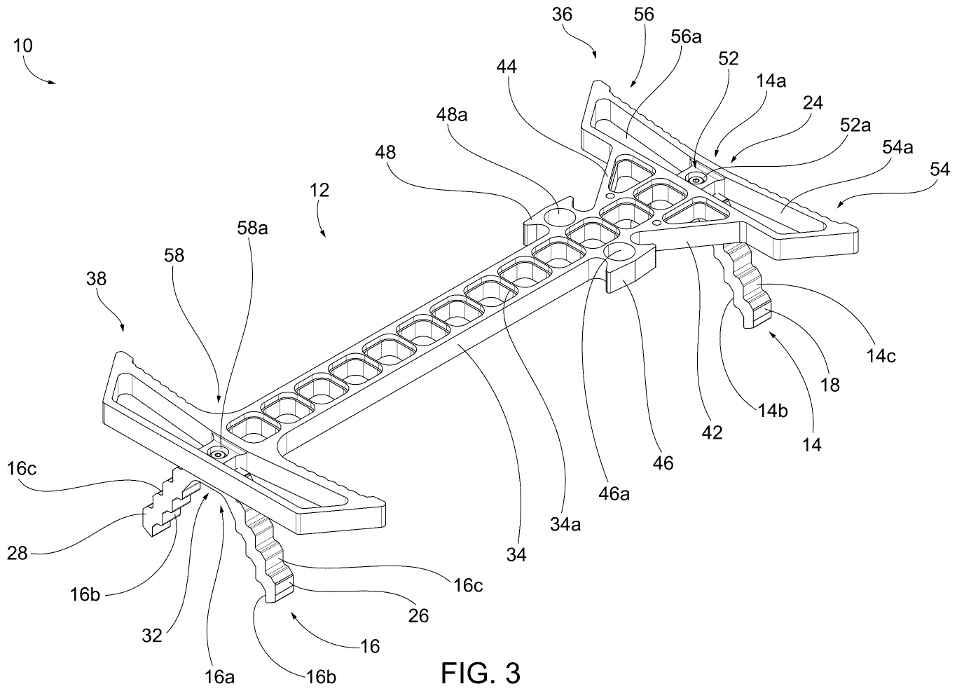

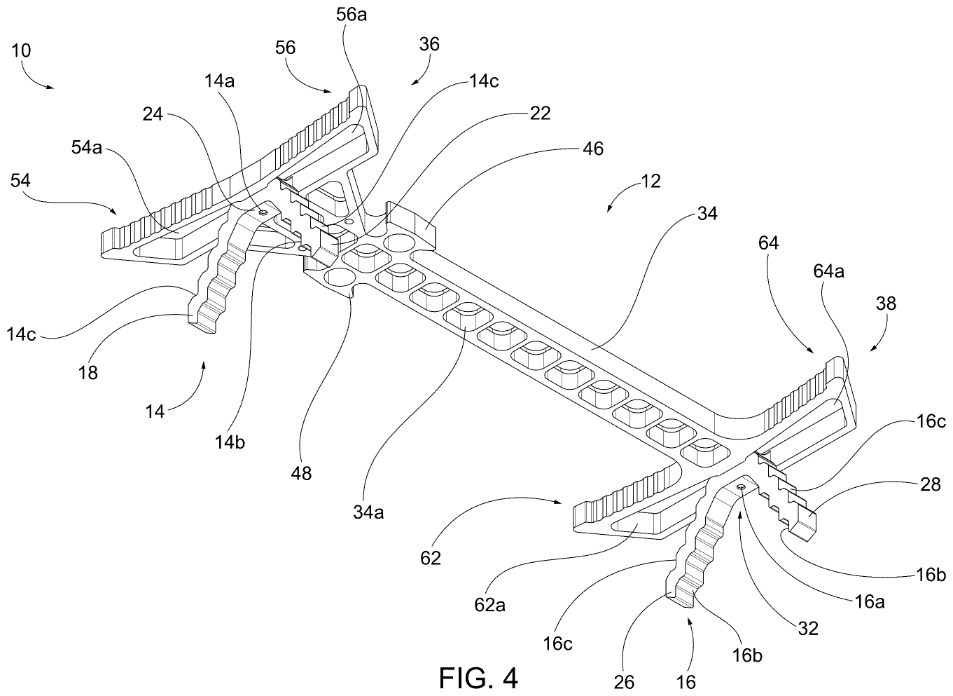

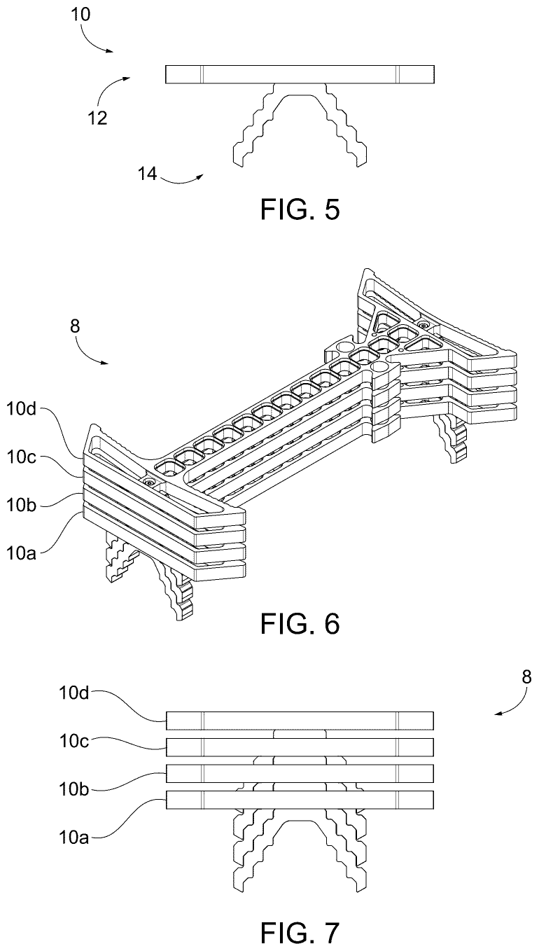

With reference to FIG. 1, a climbing stick system 8 that can include a plurality of climbing sticks 10a, 10b, 10c is shown in a deployed condition attached to a tree 11 with rope 13a, 13b, 13c. More or less climbing sticks 10 could be a part of the climbing stick system 8 without departing of the scope of this disclosure. Further, FIGS. 6-7 illustrate the climbing sticks 10a, 10b, 10c, 10d in a stowed condition. For reference, the climbing sticks 10a, 10b, 10c, 10d are identical in all respects. Accordingly, all future references to a climbing stick will simply be notated with reference number 10 to avoid duplication. Further, any discussion related to climbing stick 10 will be understood to be applicable to climbing sticks 10a, 10b, 10c, 10d, unless otherwise noted. Finally, it will be understood that the first climbing stick is indicated with reference number 10a and the second climbing stick will be indicated with reference number 10b.

As illustrated, the climbing stick 10 is shown as multiple components, but it will be understood that the climbing stick 10 could be of single element construction without departing from the scope of this disclosure. When the climbing stick 10 is made of multiple components, these components can be held together by a variety of techniques. For example, the components could be connected to one another with mechanical fasteners, welding, adhesive, and/or press-fit.

The climbing stick 10 can be made from a variety of different materials without departing from the scope of this disclosure. For example, any or all components of the climbing stick 10 could be made from aluminum, steel, magnesium, polymers, and any combination thereof. The climbing stick 10 can define a deployed condition (FIG. 1) and a stowed condition (FIGS. 6-7). The deployed condition is when the climbing stick 10 is engaging the tree 11 to aid the user in climbing the tree 11, as shown in FIG. 1. The stowed condition is when the climbing stick 10 is stacked with at least one other climbing stick 10 in a nested fashion, as shown in FIGS. 6-7.

The climbing stick 10 can include a main body 12, an upper standoff 14, and a lower standoff 16. The upper standoff 14 and the lower standoff 16 can each be V-shaped and can extend primarily in a horizontal direction when the climbing stick 10 is deployed (i.e., attached to the tree 11). The upper standoff 14 and the lower standoff 16 can be configured to engage the tree 11 so as to connect or attach the main body 12 to the tree 11. As illustrated, the upper standoff 14 and the lower standoff 16 can be identical in shape and size to one another. However, the upper standoff 14 and the lower standoff 16 could be different in shape and size from one another without departing from the scope of the disclosure.

The upper standoff 14 can include an upper first arm 18 and an upper second arm 22 that join at an upper vertex 24 and cooperate to define an upper included angle that allows for receipt of the tree 11 at least partially therein when deployed. The upper included angle can be at least 45 degrees and less than 180 degrees. When the climbing stick 10 is stowed, the climbing stick 10 can be stacked on top of another climbing stick so as to receive at least part of the upper standoff 14 of the another climbing stick, as shown in FIGS. 6-7.

The lower standoff 16 can include a lower first arm 26 and a lower second arm 28 that join at a lower vertex 32 and cooperate to define a lower included angle that allows for receipt of the tree 11 at least partially therein when deployed. The lower included angle can be at least 45 degrees and less than 180 degrees. When the climbing stick 10 is stowed, the second climbing stick 10b can be stacked on top of the first climbing stick 10a so as to receive at least part of the lower standoff of the second climbing stick 10b as illustrated in FIGS. 6-7. As noted hereinbefore, multiple climbing sticks can be stacked together.

Because of the V-shaped arrangement of the upper standoff 14 and the lower standoff 16, improved strength and rigidity is provided to the user of the climbing stick 10. As such, the user's experience of the climbing stick 10 is improved. Furthermore, because of the layout of the climbing stick 10, the user can benefit from the improved connection between the tree 11 and the climbing stick 10, while still having the system 8 (i.e., multiple climbing sticks 10a, 10x) that is compact when stowed.

The upper standoff 14 and the lower standoff 16 can define an upper bore 14a and a lower bore 16a, respectively, that can be disposed near the upper vertex 24 and the lower vertex 32, respectively, for connection or attachment with the main body 12. Further, the upper standoff 14 can include an upper inner face 14b that faces toward the tree 11 and an upper outer face 14c that faces away from the tree 11. The lower standoff 16 can include a lower inner face 16b that faces toward the tree and a lower outer face 16c that faces away from the tree 11.

The upper inner face 14b, the upper outer face 14c, the lower inner face 16b, and the lower outer face 16c can each include a stepped treatment. The stepped treatment on the upper inner face 14b and the lower inner face 16b can aid in engagement with the tree 11 and the stepped treatment on the upper outer face 14c and the lower outer face 16c can provide for improved compact stacking or nesting of multiple climbing stick 10s together when the climbing stick 10s are stowed, as will be discussed in more detail hereinafter. The upper outer face 14c and the lower outer face 16c provide no climbing obstruction when the climbing stick 10 is deployed and also allow for the ability to pack any adjacent climbing stick directly above or below another climbing stick. This stacking feature provides superior packability for the climbing sticks for transport by hand, with a backpack or fanny pack, or with a carrying strap.

The main body 12 can include a post portion 34, a plurality of steps 36, 38, a plurality of support arms 42, 44, and a plurality of tabs 46, 48. The post portion 34 can extend primarily in a vertical direction when the climbing stick 10 is deployed. Further, the post portion 34 can define a plurality of holes 34a. The holes 34a can be for a variety of purposes, including for example, weight reduction of the climbing stick 10.

As illustrated, the plurality of steps can include an upper step 36 and a lower step 38. However, it will be appreciated that the main body 12 could include more or less steps than illustrated. Further, the steps 36, 38 could be integral to the post portion 34 or separate component(s). A top surface of each of the steps can include grips to engage the user's footwear for a secure footing when in use on the tree 11 (i.e., deployed). Further, the upper standoff 14 and the lower standoff 16 of the climbing stick 10 engage the tree 11 and provide room for the user's feet on the steps 36, 38 by distancing the steps 36, 38 from the tree 11 when the climbing stick 10 is deployed (i.e., FIG. 1).

The upper step 36 can include an upper hub 52 that defines an upper hub bore 52a, an upper first portion 54, and an upper second portion 56. The upper hub bore 52a can be in registry with the upper bore 14a of the upper standoff 14 to allow a fastener to at least partially extend therethrough so as to connect the upper standoff 14 to the main body 12. The upper first portion 54 can define an upper first passage 54a and the upper second portion 56 can define an upper second passage 56a. The upper first passage 54a and the upper second passage 56a can cooperate to allow passage of an upper standoff and a lower standoff of another climbing stick when stowed. As this allows for the respective upper standoff and lower standoff to pass through the steps in such a way that each climbing stick packs directly above the front face or below the bottom face of any additional climbing stick.

The lower step 38 can include a lower hub 58 that defines a lower hub bore 58a, a lower first portion 62, and a lower second portion 64. The lower first portion 62 can define a lower first passage 62a and the lower second portion 64 can define a lower second passage 64a. The lower hub bore 58a can be in registry with the lower bore 16a of the lower standoff 16 to allow a fastener to at least partially extend therethrough so as to connect the lower standoff 16 to the main body 12. The lower first passage 62a and the lower second passage 64a can cooperate to allow passage of a lower standoff of another climbing stick when stowed.

The plurality of support arms can include a first support arm 42 and a second support arm 44. The first support arm 42 can extend from the post portion 34 to the upper first portion 54 of the upper step 36 and the second support arm 44 can extend from the post portion 34 to the upper second portion 56 of the upper step 36. The first support arm 42 and the second support arm 44 can cooperate to provide additional rigidity and strength for the climbing stick 10. As will be appreciated, additional support arms could be provided to extend from the post portion 34 to additional steps.

As illustrated, the main body 12 includes two tabs 46, 48. However, more or less tabs could be used without departing from the scope of this disclosure. The plurality of tabs 46, 48 can include a first tab 46 that defines a first opening 46a and a second tab 48 that defines a second opening 48a. The first tab 46 and the second tab 48 can be a variety of shapes without departing from the scope of this disclosure. Further, the rope 13a, 13b, 13c can be passed through the first opening 46a and the second opening 48a when the climbing stick 10 is deployed to attach the climbing stick 10 to the tree 11, as shown in FIG. 1. The tabs 46, 48 can be used with either a fixed end or an adjustable end of the rope 13a, 13b, 13c.

Because of the layout of the climbing stick 10, the user can pass the rope 13a, 13b, 13c through the climbing stick 10a, 10b, 10c to create a secure ‘hitch’ on both adjacent sides, always ensuring consistent attachment. This allows the user to pass the secure loops of the provided attachment method through the tabs 46, 48 from back to front, and back over the tab 46, 48.

Climbing sticks have been described above with particularity. Modifications and alterations will occur to those upon reading and understanding the preceding detailed description. The invention, however, is not limited to only the embodiments described above. Instead, the invention is broadly defined by the appended claims and the equivalents thereof.

1. A climbing stick system, comprising:
a first climbing stick; and
a second climbing stick, the first climbing stick and the second climbing stick cooperating to define a deployed condition when attached to an associated tree so as to allow an associated user to ascend and descend the associated tree, wherein the first climbing stick and the second climbing stick each include
a main body;
at least one standoff extending from the main body and configured to engage the associated tree; and
at least one step configured to engage an associated foot of the associated user when in the deployed condition, wherein the at least one step of the first climbing stick defines at least one passage configured to receive at least part of the standoff of the second climbing stick when the first climbing stick and the second climbing stick are removed from the associated tree and the second climbing stick is stacked on top of the first climbing stick so as to define a stowed condition.

2. The climbing stick system of claim 1, wherein the at least one step of the first climbing stick and the second climbing stick each include an upper step and a lower step for selective engagement with the associated foot of the associated user.

3. The climbing stick system of claim 2, wherein the upper step of the first climbing stick and the upper step of the second climbing stick each define an upper first passage and an upper second passage, and the lower step of the first climbing stick and the lower step of the second climbing stick each define a lower first passage and a lower second passage.

4. The climbing stick system of claim 1, wherein the at least one standoff of the second climbing stick includes an upper first arm and an upper second arm that join at an upper vertex and cooperate to define an upper included angle of the second climbing stick that allows for receipt of the associated tree at least partially therein when in the deployed condition.

5. The climbing stick system of claim 4, wherein the upper first arm of the second climbing stick and the upper second arm of the second climbing stick each include an inner face that faces toward the associated tree when in the deployed condition and an outer face that faces in an opposite direction as the respective inner face of the second climbing stick and away from the associated tree when in the deployed condition.

6. The climbing stick system of claim 5, wherein the upper first arm of the second climbing stick defines a stepped shape so that a straight line extending from the upper vertex of the second climbing stick to a terminal end of the upper first arm of the second climbing stick along the inner face of the upper first arm of the second climbing stick does not maintain constant contact with the inner face of the upper first arm of the second climbing stick.

7. The climbing stick system of claim 6, wherein a straight line extending from the upper vertex of the second climbing stick to the terminal end of the upper first arm of the second climbing stick along the outer face of the upper first arm of the second climbing stick does not maintain constant contact with the outer face of the upper first arm of the second climbing stick.

8. The climbing stick system of claim 7, wherein the upper second arm of the second climbing stick defines a stepped shape so that a straight line extending from the upper vertex of the second climbing stick to a terminal end of the upper second arm of the second climbing stick along the inner face of the upper second arm of the second climbing stick does not maintain constant contact with the inner face of the upper second arm of the second climbing stick.

9. The climbing stick system of claim 8, wherein a straight line extending from the upper vertex of the second climbing stick to the terminal end of the upper second arm of the second climbing stick along the outer face of the upper second arm of the second climbing stick does not maintain constant contact with the outer face of the upper second arm of the second climbing stick.

10. The climbing stick system of claim 2, wherein the main body of the first climbing stick includes a post portion that extends between the upper step of the first climbing stick and the lower step of the first climbing stick, the post portion extending primarily in a vertical direction when the first climbing stick is in the deployed condition, and the post portion of the first climbing stick defines a plurality of holes that cooperate to define a hole volume, and wherein the at least one passage of the first climbing stick defines a passage volume of the first climbing stick that is less than the hole volume of the first climbing stick.

11. The climbing stick system of claim 3, wherein the upper passage of the first climbing stick and the lower first passage of the first climbing stick define an upper passage first climbing stick volume and a lower passage first climbing stick volume, wherein the upper passage first climbing stick volume and the lower passage first climbing stick volume are equal to one another, wherein the upper passage of the second climbing stick defines an upper passage second climbing stick volume and the lower passage of the second climbing stick defines a lower second passage second climbing stick volume, and wherein the upper passage second climbing stick volume is equal to the lower second passage second climbing stick volume.

12. The climbing stick system of claim 11, wherein a sum of the upper passage first climbing stick volume and the lower passage first climbing stick volume is equal to a sum of the upper passage second climbing stick volume and the lower second passage second climbing stick volume.

13. The climbing stick system of claim 6, wherein the at least one standoff of the first climbing stick includes an upper first arm and an upper second arm that join at an upper vertex and cooperate to define an upper included angle of the first climbing stick that allows for receipt of the associated tree at least partially therein when in the deployed condition.

14. The climbing stick system of claim 13, wherein the upper first arm of the first climbing stick and the upper second arm of the first climbing stick each include an inner face that faces toward the associated tree when in the deployed condition and an outer face that faces in an opposite direction as the respective inner face and away from the associated tree when in the deployed condition.

15. The climbing stick system of claim 14, wherein the upper first arm of the first climbing stick defines a stepped shape so that a straight line extending from the upper vertex of the first climbing stick to a terminal end of the upper first arm of the first climbing stick along the inner face of the upper first arm of the first climbing stick does not maintain constant contact with the inner face of the upper first arm of the first climbing stick.

16. The climbing stick system of claim 15, wherein the outer face of the upper first arm of the first climbing stick and the outer face of the upper second arm of the first climbing stick directly contact the inner face of the upper first arm of the second climbing stick and the inner face of the upper second arm of the second climbing stick when in the stowed condition.

17. The climbing stick system of claim 16, wherein the at least one step of the first climbing stick is spaced from the at least one step of the second climbing stick when in the stowed condition.

18. The climbing stick system of claim 2, wherein the main body of the first climbing stick includes a post portion that extends between the upper step of the first climbing stick and the lower step of the first climbing stick, the post portion extending primarily in a vertical direction when the first climbing stick is in the deployed condition, wherein the main body also includes a first support arm that extends from the post portion to an upper first portion of the upper step and a second support arm that extends from the post portion to an upper second portion of the upper step.

19. The climbing stick system of claim 18, wherein the first support arm, the post portion, and the upper step cooperate to define a first support void, and the second support arm, the post portion, and the upper step cooperate to define a second support void, wherein the first support void defines a first support void volume and the second support void defines a second support void that is equal to the first support void, wherein the upper first passage of the first climbing stick and the upper second passage of the first climbing stick define an upper first passage volume and an upper second passage volume, respectively, and wherein the upper first passage volume and the upper second passage volume are greater than the first support void volume and the second support void volume, respectively.

20. The climbing stick system of claim 3, wherein the main body of the first climbing stick includes a first tab that defines a first opening and a second tab that defines a second opening, the first opening and the second opening of the first and second tab, respectively, configured to allow passage of an associated rope to be passed therethrough to attach the first climbing stick to the associated tree, wherein the first opening and the second opening define a first opening volume and a second opening volume, respectively, wherein the upper passage of the first climbing stick and the lower first passage of the first climbing stick define an upper passage first climbing stick volume and a lower passage first climbing stick volume, and wherein a sum of the first opening volume and the second opening volume is less than a sum of the upper passage first climbing stick volume and the lower passage first climbing stick volume.
